(19) United States
(12) Patent Application Publication
(10) Pub. No.: US 2018/0009065 A1
(43) Pub. Date: Jan. 11, 2018

(54) ABRASIVE TOOL HAVING A BRAZE JOINT WITH INSOLUBLE PARTICLES

(71) Applicant: DIAMOND INNOVATIONS, INC., Worthington, OH (US)

(72) Inventors: Thomas EASLEY, Bexley, OH (US); David Chmelik, Schramberg (DE)

(21) Appl. No.: 15/639,768

(22) Filed: Jun. 30, 2017

Related U.S. Application Data
(60) Provisional application No. 62/358,260, filed on Jul. 5, 2016.

(51) Int. Cl. B23K 35/30

(52) U.S. Cl. CPC B23K 35/3006

(57) ABSTRACT

Multi-part abrasive tools are disclosed herein. In one embodiment, an abrasive tool includes a first body, a second body, and a braze layer that couples the first body to the second body. The braze layer includes a braze alloy having a liquidus temperature and insoluble particles at least partially surrounded by the braze alloy. The insoluble particles are insoluble with the braze alloy at temperatures at least 100° C. above the liquidus temperature of the braze alloy.

### CROSS-REFERENCE TO RELATED APPLICATIONS

None.

### TECHNICAL FIELD AND INDUSTRIAL APPLICABILITY

The present application relates generally to abrasive tools having braze joints between adjoining components and, more particularly, braze joints for abrasive tools having insoluble particles in the braze joint to improve the elevated temperature performance of the braze joint.

### BACKGROUND

Abrasive tools may be used in a variety of applications, such as machining, cutting, grinding, polishing and/or drilling metals, metal alloys, composites, glass, plastics, wood, rocks, geological formations, subterranean formations, paved surfaces, and ceramics. A working portion of the abrasive tool may be made from a hard material, for example, diamond, cubic boron nitride, or a carbide, and may be bonded to a substrate. The working portion of the abrasive tool may exhibit improved performance characteristics that provide better abrasive tool performance in the selected application. However, the working portion of the abrasive tool may not be readily attached to a tool holder, or it may be cost prohibitive for the entire abrasive tool to be made of the material having the preferred properties.

It is conventionally known to joint dissimilar materials through use of a braze joint. In conventional brazing attachments, a filler metal is introduced between adjacent portions that are to be attached. The filler metal is heated to a temperature above its liquidus temperature and the filler metal flows into a gap between the adjacent portions, including flowing by capillary action. When the filler metal cools, the filler metal joins the adjacent portions into an integral body.

Braze joints, however, have been limited in their strength, particularly at elevated temperatures. Because the filler alloy is brought above its liquidus temperature to complete the braze process, and using lower temperatures to complete the brazing processes preserves the integrity of the adjacent portions that are being brazed to one another, the filler metal typically loses strength quickly as temperatures rise. Further, because the strength of the braze joint depends on the strength of the filler metal, the braze joint also typically loses strength quickly as temperatures rise and the strength of the filler alloy decreases.

Accordingly, braze joints with improved high temperature performance may be desired.

### SUMMARY

In one embodiment, an abrasive tool includes a first body, a second body, and a braze layer that couples the first body to the second body. The braze layer includes a braze alloy having a liquidus temperature and insoluble particles at least partially surrounded by the braze alloy. The insoluble particles are insoluble with the braze alloy at temperatures at least 100° C. above the liquidus temperature of the braze alloy.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 is a schematic side view of an abrasive tool having a braze joint according to one or more embodiments shown or described herein;

FIG. 2 is a schematic side view of a braze joint according to one or more embodiments shown or described herein; and

FIG. 3 is a plot of data relating shear strength to temperature of braze joints according to one or more embodiments shown or described herein.

### DETAILED DESCRIPTION

Embodiments according to the present disclosure include an abrasive tool having a first body, a second body, and a braze layer that couples the first body to the second body. The braze layer includes a braze alloy having a liquidus temperature and insoluble particles at least partially surrounded by the braze alloy. The insoluble particles are insoluble with the braze alloy at temperatures at least 100° C. above the liquidus temperature of the braze alloy. The insoluble particles may act as a dispersion strengthening member to increase the yield strength of the braze alloy or to increase the high temperature performance of the braze alloy.

Conventionally known braze alloys, when used in such applications, typically exhibit a substantial decrease in strength as the temperature of the braze alloy increases. In particular end-user applications, the material removal process introduces high temperatures to the surfaces of the abrasive tool that are in contact with the material being removed. The heat generated in the material removal process conducts along the abrasive tool and into the braze alloy itself.

Under certain conditions, the increase in temperature of the braze alloy may result in significant reduction of the yield strength of the braze alloy, thereby leading to premature failure of the abrasive tool when the abrasive tool is subjected to stresses of the material removal operation. Accordingly, it is believed that increasing the strength of the braze joint in the abrasive tool, including increasing the strength when subjected to high temperatures, may increase the performance of the abrasive tool.

The present disclosure is directed to embodiments of abrasive tools having a braze layer between a first body and a second body, where the braze layer includes a braze alloy and insoluble particles that are at least partially surrounded by the alloy. The inventors have determined that the incorporation of the insoluble particles into the braze layer increase the temperature at which drop off in the yield strength of the braze layer occurs, and decreases the rate of yield strength drop off as the temperatures of the braze layer continue to climb, as compared to the same braze alloy without the addition of the insoluble particles. This result is surprising, as the yield strength of the braze layer did not exhibit any apparent increase at room temperatures upon addition of the insoluble particles.

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, “about 40” means in the range of 36-44.

The term “brazed” refers to an object which has been joined by a brazing process.

The term “brazing” means a metal joining process whereby a braze metal or alloy is melted by heating the braze metal or alloy above the liquidus temperature of the braze metal or alloy and bringing the melted brazed metal into contact with at least two objects such that, when the temperature goes below the solidus temperature of the braze metal or alloy, the two objects are joined (bound) by at least the braze metal or alloy to each other. For example, a braze metal or alloy may be melted and the liquid braze metal or alloy may be brought into contact with multiple bodies to fasten the bodies to one another.

As discussed hereinabove, the present disclosure is directed to embodiments of abrasive tools having a braze layer between a first body and a second body, where the braze layer includes a braze alloy and insoluble particles that are at least partially surrounded by the alloy. The insoluble particles act as dispersion strengthening elements at elevated temperatures. The addition of the insoluble particles increases a critical temperature at which yield failure is accelerated, and decreases the rate of strength decrease at temperatures above this critical temperature. The addition of the insoluble particles, however, have little apparent effect on the yield strength of the braze layer at room temperature.

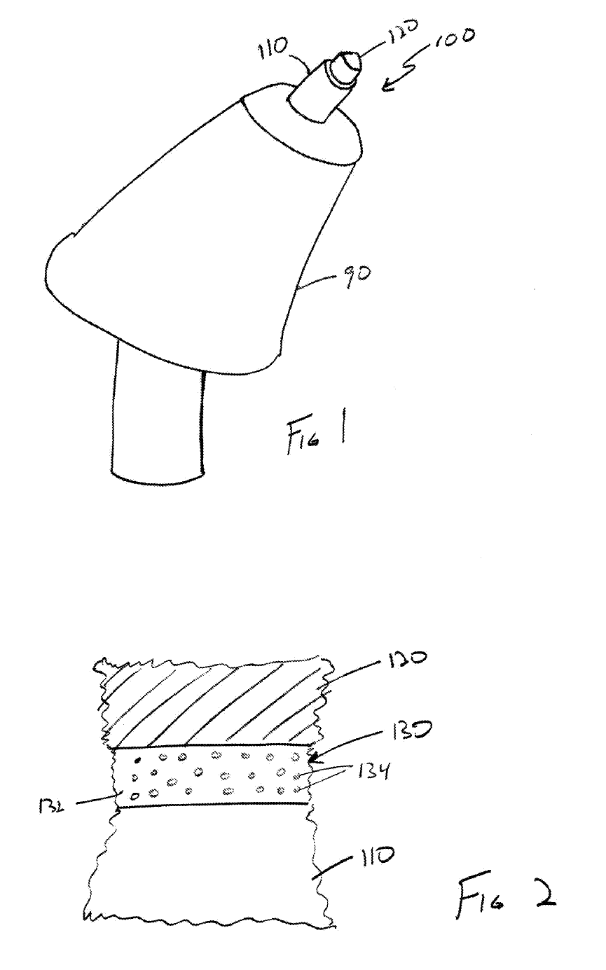

Referring to FIG. 1, a schematic representation of an abrasive tool 100 according to the present disclosure is depicted. In the depicted embodiment, the abrasive tool 100 is mounted in an optional tool holder 90, which itself may be secured to a machine for completion of a material removal operation. The abrasive tool 100 includes a first body 110 and a second body 120. As depicted, the second body 120 makes up the primary contact portion of the abrasive tool 100 that will come into contact with the material to be removed in a material removal operation. The second body 120 is attached to the first body 110 through a braze layer 130. The first body 110, therefore, supports the second body 120, and allows the second body 120 to be mounted in the tool holder 90.

In a material removal operation, in general, the second body 120 makes direct contact with the material to be removed, such that the second body 120 is subjected to conditions of highest abrasion and highest forces of the material removal process. The first body 110 may also be subject to wear, however, it is generally intended that the second body 120 absorbs the majority of the energy of the material removal process. Because the second body 120 absorbs the majority of the energy of the material removal process, it may be desirable for the second body 120 to be made from a material that is highly abrasion resistant. In contrast, because the first body 110 does not absorb the majority of the energy of the material removal process, the first body 110 may be made from a material that exhibits less abrasion resistance than the second body 120.

The materials from which the first body 110 and the second body 120 are made may vary based on the particular end user application. However, in most applications, the material from which the second body 120 is made is generally more abrasion resistant and/or more tough than the material from which the first body 110 is made. In particular, the first body 110 may be made from a hard metal carbide, for example, cemented tungsten carbide, or a high strength steel. The second body 120 may be made from a so-called superabrasive body, for example, a diamond body, such as a polycrystalline diamond body or a composite diamond body, or a polycrystalline cubic boron nitride body. In some embodiments, the second body 120 may also be made from a hard metal carbide, for example, cemented tungsten carbide, that has different material properties than the first body 110. In other embodiments, the first body 110 may be made from a so-called superabrasive body as described above that has different material properties than the superabrasive body from which the second body 120 is made. In a particular embodiment, the second body 120 may be made from a silicon carbide-bonded diamond composite, such as Versimax (produced by Diamond Innovations, Inc., Worthington, Ohio, USA) and the first body 120 may be made from a cemented tungsten carbide.

As depicted in FIG. 2, the first body 110 and the second body 130 are coupled to one another by a braze layer 130. The braze layer 130 includes a braze alloy 132 that may be selected from a variety of conventionally known braze metals that are suitable for brazing the materials of the first body 110 and the second body 120. The braze alloy 132 may include silver, copper, manganese, nickel, zinc, platinum, chromium, boron, titanium, tin, silicon, cadmium, gold, palladium, aluminum, indium, niobium, tungsten, molybdenum, rhenium, zirconium, hafnium, or an alloy or composite thereof.

In some embodiments, the braze alloy 132 may be classified as an active metal braze, such that the components of the braze alloy 132 allow for metallic attachment of the braze alloy 132 to a ceramic material, for example the first body 110 and/or the second body 120, as described hereinabove, without the use of an additional wetting agent or a coating on the ceramic material.

In some embodiments, the braze alloy 132 may include silver and copper and an addition of a refractory metal that acts as the active metal in the braze alloy, such as, for example, the addition of titanium, niobium, tungsten, molybdenum, rhenium, zirconium, hafnium, chromium or alloys or combinations thereof. In some embodiments, the braze alloy 132 may include titanium, which may be present in a range from about 1 wt. % to about 5 wt. %, for example being present in a range from about 2 wt. % to about 4 wt. %, for example being about 3 wt. %. In one embodiment, the braze alloy 132 may have a nominal composition of 59 wt. % silver, 27.25 wt. % copper, 12.5 wt. % indium, and 1.25 wt. % titanium, such as the INCUSIL™ family of brazes (commercially available from Morgan Advanced Ceramics, Inc. of Fairfield, N.J., USA). In some embodiments, the braze alloy 132 may have a relatively low liquidus temperature, for example, having a liquidus temperature below about 850° C., for example being below about 800° C., for example being below about 750° C., for example being below about 700° C., for example being below about 650° C. The relatively low liquidus temperature of the braze alloy 132 allows for completion of a braze process at a relatively low temperature, which may minimize thermal damage to the first and second bodies 110, 120. In other embodiments, the braze alloy 132 may have a relatively high liquidus temperature, for example having a liquidus temperature that is in a range from about 850° C. to about 1050° C. Such braze alloys may exhibit good strength at relatively high temperatures.

Still referring to FIG. 2, the braze layer 130 also includes a plurality of insoluble particles 134 that are at least partially surrounded by the braze alloy 132. As will be discussed in greater detail below, the insoluble particles 134 may improve the strength of the braze layer 130 such that the yield strength of the braze layer 130 exceeds the yield strength of the braze alloy 132 absent the insoluble particles at elevated temperatures.

The insoluble particles 134 are insoluble with the braze alloy 132 in which they are positioned at temperatures of at least 100° C. above the liquidus temperature of the braze alloy 132. In some embodiments, the insoluble particles 134 may react with the braze alloy 132 while the braze alloy 132 is in a liquid state to form a reaction product along the external surfaces of the insoluble particles 134, however any reaction between the insoluble particles 134 and the braze alloy 132 would result in substantial change in the size of the insoluble particles 134 that may be confused with solubility.

The insoluble particles 134 may be selected from a variety of materials, including refractory metals, composites, or ceramic materials. In particular, the insoluble particles 134 may be selected from diamond, cubic boron nitride, cemented tungsten carbide, Al₂O₃, TiN, TiC, Ti(C,N), SiC, and refractory metals such as Mo, Ta, W, and the like. The insoluble particles 134 may make up less than about 20 vol. % of the braze layer 130, for example, being in a range from about 5 vol. % to about 15 vol. % of the braze layer 130, for example being in a range from about 8 vol. % to about 12 vol. % of the braze layer 130.

In some embodiments, the braze alloy 132 may be supplied as a paste in which the constituent metals are powders that are well mixed and incorporated in a binder. The insoluble particles 134 may be blended with the braze alloy 132 prior to introduction of the braze alloy 132 between the first body 110 and the second body 120. The maximum ratio of insoluble particles 134 that may provide the benefit of increased strength may be limited by adequate and even distribution of the insoluble particles 134 in the paste and the ability of the paste to melt and fill any gaps between adjacent bodies during the braze operation. For example, too high of an addition of insoluble particles 134 may increase the viscosity of the braze alloy 132 and prevent the braze alloy 132 from filling gaps between adjacent bodies.

In some embodiments, the insoluble particles 134 may have a particle size distribution with a D50 of less than about 10 μm, for example about 5 μm or less. The relatively fine size of the insoluble particles 134 may allow for even distribution throughout the braze layer 130. Additionally, a decrease in particle size of the insoluble particles 134 may increase the strength of the braze joint. Furthermore, maintaining a concentration of insoluble particles 134 and decreasing the particle size may increase the viscosity and increase the yield strength of the braze alloy, so long as the viscosity of the braze alloy remains in a range in which the braze alloy continues to fill gaps between adjacent bodies and fully densifies during the braze operation. In one embodiment, the insoluble particles 134 may be diamond grains having a D50 of less than or equal to about 5 μm.

After the braze alloy 132 and the insoluble particles 134 are mixed with one another into a braze paste, the braze paste may be metered and distributed between the first body 110 and the second body 120. The intermediate assembly may then be subjected to a braze process in which at least portions of the first body 110, the second body 120, and the braze alloy 132 are brought to a temperature greater than the liquidus temperature of the braze alloy 132, such that the braze alloy 132 is permitted to melt and densify. Some of the braze alloy 132 may be drawn through capillary forces into the first body 110 and the second body 120. Heat may be removed from the assembly and the first body 110, the second body 120, and the newly formed braze layer 130 are allow to cool. In general, braze layers 130 exhibiting smaller thicknesses are preferred for providing better strength than thicker braze layers. The braze process may form a braze layer 130 having a thickness in a range from about 25 μm to about 75 μm, for example, being in a range from about 35 μm to about 50 μm. The abrasive tools 100 may a ratio x of a D50 of the insoluble particles 134 to a thickness of a braze layer 130 is in a range of about 0.08≦x≦0.20, and preferably in a range of about 0.10≦x≦0.15.

Without being bound by theory, it is believed that the addition of the insoluble particles to the braze layer may act as a dispersion strengthening element that prevents dislocations from extending through the braze layer, thereby supplementing the yield strength of the braze layer. However, in somewhat surprising results, an increase in yield strength has not been exhibited at room temperature. Instead, experimental results have demonstrated that the yield strength remains consistent at higher temperatures for samples that include the insoluble particles as compared to samples that do not include insoluble particles. Maintaining consistent yield strength at increasing temperatures is a beneficial property for a variety of end-user applications, as the temperatures introduced to the portion of the abrasive tool that contacts the material that is being removed typically induces high temperatures into the abrasive tool in general, and to the braze layer in particular. Therefore, the increase in critical temperature at which yield strength of the braze layer begins to drop is beneficial for abrasive tool performance. The addition of the insoluble particles allows for the use of relatively low-melting temperature braze alloys in the braze joint, which allows for minimal heat to be introduced to during the brazing process, thereby minimizing thermal damage to the first and second bodies (including the superabrasive bodies) that are brazed to one another. Furthermore, by enabling the use of low-melting temperature braze alloys, braze operations completed according to the present disclosure may reduce any residual thermal stresses that are induced to the joined bodies due to mismatch of the coefficients of thermal expansion of those bodies.

### EXAMPLES

A series of sample articles having geometry that matched an abrasive tool design was produced to evaluate the yield strength of the braze joint between a VERSIMAX body and a cemented tungsten carbide body through a shear strength test. The sample articles were subjected to shear strength testing at a variety of temperatures to evaluate the performance of the braze joint at increasingly elevated temperatures.

### Comparative Example A

Samples were produced with a braze layer made from INCUSIL-25-ABA without any insoluble particle addition to the braze layer. INCUSIL-25-ABA braze paste was positioned between the cemented tungsten carbide body and the VERSIMAX body. The pre-assembly was subjected to a braze operation at about 650° C. in a vacuum brazing furnace with a vacuum pressure less than about 5×10⁻⁵ torr at the brazing temperature. Based on previous experience, it was recognized that these furnace conditions produced high quality braze joints between the cemented tungsten carbide body and the VERSIMAX body.

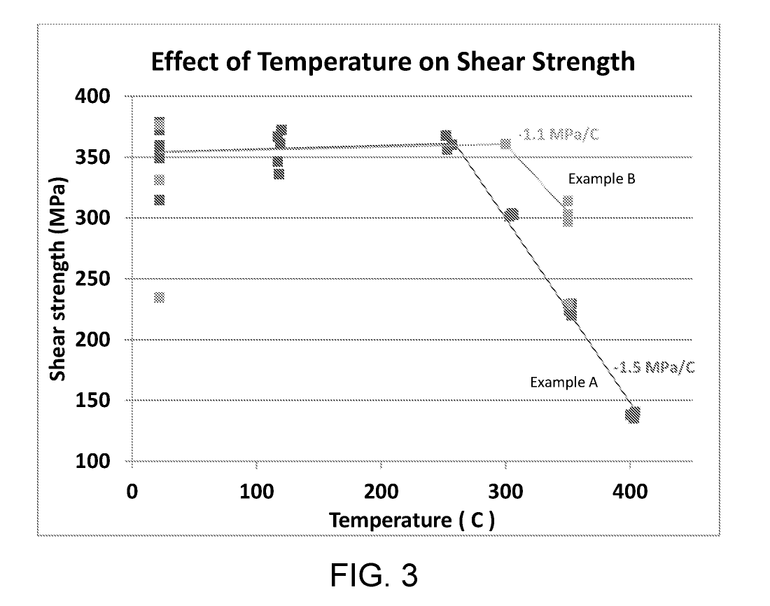

Samples were tested at 22° C., 250° C., 300° C., 350° C., and 400° C. Data gathered from the tests are reproduced in FIG. 3, and labeled as “Example A”. The average shear strength at 22° C. was 357 MPa. As can be seen in FIG. 3, the shear strength was roughly constant from ambient temperature to about 250° C. At temperatures above 250° C., the shear strength of the samples began to decrease at a rate of about 1.5 MPa/° C. Based on the test results, it was determined that 250° C. was the critical temperature at which the shear strength of the braze joint began to decrease.

### Example B

Samples were produced with a braze layer made from 90 vol. % INCUSIL-25-ABA with 10 vol. % MBM 4-6 μm diamond (available from Diamond Innovations, Inc., Worthington, Ohio, USA) added to the braze layer. The combination braze paste was positioned between the cemented tungsten carbide body and the VERSIMAX body. The pre-assembly was subjected to a braze operation at about 740° C. in a vacuum brazing furnace with a vacuum pressure less than about 5×10⁻⁵ torr at the brazing temperature. It was found that higher brazing temperatures were required to demonstrate the higher temperature strengthening effect disclosed hereinabove.

Samples were tested at 22° C., 250° C., 300° C., and 350° C. Data gathered from the tests are reproduced in FIG. 3, and labeled as “Example B”. The average shear strength at 22° C. was 356 MPa, excluding one outlier data point. As can be seen in FIG. 3, the shear strength was roughly constant from ambient temperature to about 300° C. At temperatures above 300° C., the shear strength of the samples began to decrease at a rate of about 1.1 MPa/° C. Based on the test results, it was determined that 300° C. was the critical temperature at which the shear strength of the braze joint began to decrease.

It should now be understood that abrasive tools according to the present disclosure includes a braze layer that is positioned between multiple bodies. The braze layer includes a braze alloy and insoluble particles that are at least partially surrounded by the braze alloy. The addition of the insoluble particles to the braze alloy maintaining the yield strength of the braze joint at higher temperatures than the braze alloy without the insoluble particles. The increase in the critical temperature allows for more force to be resisted by the braze joint at higher temperatures, which allows for higher tool forces to be applied to the abrasive tool.

Although described in connection with preferred embodiments thereof, it will be appreciated by those skilled in the art that additions, deletions, modifications, and substitutions not specifically described may be made without department from the spirit and scope of the invention as defined in the appended claims.

1. An abrasive tool, comprising:
a first body;
a second body; and
a braze layer coupling the first body to the second body, the braze layer comprising:
a braze alloy having a liquidus temperature; and
insoluble particles at least partially surrounded by the braze alloy, wherein the insoluble particles are insoluble with the braze alloy at temperatures at least 100° C. above the liquidus temperature of the braze alloy.

2. The abrasive tool of claim 1, wherein the first body is a diamond body comprising polycrystalline diamond or composite diamond.

3. The abrasive tool of any of claims 1-2, wherein the second body is a hard metal carbide substrate.

4. The abrasive tool of any of claims 1-3, wherein the insoluble particles are selected from a group consisting of ceramics, diamond, cubic boron nitride, and refractory materials.

5. The abrasive tool of any of claims 1-4, wherein the insoluble particles maintain a yield strength of the braze layer at temperatures above about 250° C.

6. The abrasive tool of any of claims 1-5, wherein the braze alloy comprises an active metal braze alloy.

7. The abrasive tool of claim 6, wherein the active metal braze alloy comprises titanium.

8. The abrasive tool of claim 7, wherein the active metal braze alloy comprises from about 1 wt. % to about 5 wt. % titanium.

9. The abrasive tool of claim 7, wherein the active metal braze alloy comprises about 3 wt. % titanium.

10. The abrasive tool of any of claims 1-9, wherein the braze alloy comprises silver and copper.

11. The abrasive tool of claim 10, wherein the braze alloy further comprises indium.

12. The abrasive tool of any of claim 1-9, wherein the metal alloy comprises molybdenum.

13. The abrasive tool of any of claims 3-12, wherein the hard metal carbide substrate comprises cemented tungsten carbide.

14. The abrasive tool of any of claims 1-13, wherein the braze layer comprises less than about 20 vol. % insoluble particles, and preferably from about 8 vol. % to about 12 vol. % insoluble particles.

15. The abrasive tool of any of claims 1-14, wherein the insoluble particles exhibit a D50 of less than about 10 μm, and preferably less than or equal to about 5 μm.

16. The abrasive tool of any of claims 1-15, wherein a ratio x of a D50 of the insoluble particles to a thickness of a braze layer is in a range of about 0.08≦x≦0.20, and preferably in a range of about 0.10≦x≦0.15.

17. The abrasive tool of any of claims 1-16, wherein the insoluble particles are diamond particles, and the external surfaces of the diamond particles form a reaction product with the active metal braze alloy.

18. The abrasive tool of any of claims 1-16, wherein the liquidus temperature of the braze alloy is less than about 750° C., and preferably less than about 650° C.

19. The abrasive tool of any of claims 1-16, wherein the liquidus temperature of the braze alloy is in a range from about 800° C. to about 1050° C.

20. The abrasive tool of any of claims 1-19, wherein the braze layer having the braze alloy and the insoluble particles exhibits a higher critical temperature at which its strength decreases than a critical temperature of the braze alloy alone.
